(19) United States
(12) Patent Application Publication
(10) Pub. No.: US 2016/0266819 A1
(43) Pub. Date: Sep. 15, 2016

(54) METHOD FOR DETERMINING OPERATION CONIDITIONS FOR A SELECTED LIFETIME OF A SEMICONDUCTOR DEVICE

(71) Applicant: TELEFONAKTIEBOLAGET L M ERICSSON (PUBL), Stockholm (SE)

(72) Inventor: Enar SUNDELL, Älvsjö (SE)

(21) Appl. No.: 15/024,558

(22) PCT Filed: Oct. 3, 2013
(86) PCT No.: PCT/SE2013/051159

§ 371 Date: Mar. 24, 2016

(51) Int. Cl. G06F 3/06

(52) U.S. Cl. CPC G06F 3/0616; G06F 3/0629; G06F 3/0673

(57) ABSTRACT

It is disclosed a method for determining operation conditions for a semiconductor device compatible with a selected lifetime of the semiconductor device. Information of lifetime and operation condition statistics, as well as the operation history of a semiconductor device is assessed. An accumulated wear measure is then determined from the information of lifetime and operation condition statistics, based on the assessed historical operation data. A selected lifetime for the semiconductor device is then obtained. It is then determined operation conditions that are compatible with the selected lifetime of the semiconductor device, based on the determined accumulated wear measure. After having operated the semiconductor device, reuse of the semiconductor device is enabled by updating the operation history, based on which a novel determination of operation conditions can be determined.

### TECHNICAL FIELD

This disclosure relates to determining operation conditions compatible with a selected lifetime. In more particular, it relates to a method and an arrangement for determining operation conditions compatible with a selected lifetime of a semiconductor device.

### BACKGROUND

The lifetime of a high performance processor such as a server blade, is mainly determined by the lifetime of processor components or a few high power dissipating components.

There are a number of aging and failure mechanisms that can physically affect a semiconductor device and shorten its operating life. Based on studies of those mechanisms, predictions can be made of the effects of the device's operating conditions on the device's operating life. Using those predictions, designers can pick a design operating life and then specify operating limits, for example, limits on voltage, temperature, etc., which will allow the device to reach its design operating life. The operating limits are typically enforced during operation to prevent the device from exceeding said operation limits.

From U.S. Pat. No. 7,765,412 B1, a method and a system for dynamically changing a device's operating conditions are known. It is predicted that operating a processor at conditions less than its operating limits, would cause the predicted operating lifetime to exceed its design lifetime. Having operated a processor at those conditions, the processor may then be operated at, for example, higher voltages, temperatures and frequencies for periods of time, without reducing its predicted operating lifetime of the processor to less than its design operating lifetime.

Patent application US200910287909 A1 concerns dynamical estimations of remaining lifetime of semiconductor devices. The lifetime estimations may take into account both an active time of the semiconductor device, as well as time during which a device is in an idle state. A determination of usage of the device, or a so-called mileage, can be performed at a periodic interval so that lifetime estimation may accurately reflect dynamic operating conditions of the device. At various intervals, the determined usage can be compared to a static estimation of the device lifetime. In this manner, an estimated remaining lifetime may be regularly determined. Using this estimated remaining lifetime, the device may be controlled in a fashion to extend its lifetime, for example, or to otherwise control the device to improve or continue its performance in light of remaining device capabilities.

It is thus known to dynamically change device operating conditions to meet a design operating lifetime. However, this can limit the usage of a processor to the application for which the processor was designed.

It would be advantageous with a more general applicability of a processor designed for a variety of applications, conditions and environments.

### SUMMARY

It is an object of embodiments of the invention to address at least some of the issues outlined above, and this object and others are achieved by a method and an arrangement for determining operation conditions of a semiconductor, according to the appended independent claim, and by the embodiments according to the dependent claims.

According to one aspect, the invention provides a method for determining operation conditions of a semiconductor, is presented. The operation conditions are compatible with a selected lifetime of the semiconductor device. The method comprises assessing information of predicted lifetime and operation condition statistics, based on obtained type of semiconductor device. It further comprises assessing data of an operation history of the semiconductor device. The method further comprises determining an accumulated wear measure of the semiconductor device from information of predicted lifetime and operation condition statistics, based on the assessed data of the operation history of the semiconductor device. Moreover, the method comprises obtaining a selected lifetime of the semiconductor device. In addition, it comprises determining operation conditions compatible with the selected lifetime of the semiconductor device, based on the determined accumulated wear measure.

According to another aspect of the invention, an arrangement that is configured for determining operation conditions of a semiconductor, is presented, for which the operation conditions are compatible with a selected lifetime of the semiconductor device. The arrangement comprises a processor and a memory, wherein the memory stores a computer program that comprises instructions. When these instructions are run by the processor, they cause the arrangement to assess information of predicted lifetime and operation condition statistics, based on obtained type of semiconductor device. When these instructions are run by the processor, they further cause the arrangement to assess data of an operation history of the semiconductor device, and to determine an accumulated wear measure of the semiconductor device from information of predicted lifetime and operation condition statistics, based on the assessed data of the operation history of the semiconductor device. Still further, when these instructions are run by the processor, they cause the arrangement to obtain a selection of lifetime of the semiconductor device; and to determine operation conditions compatible with the selected lifetime of the semiconductor device, based on the determined accumulated wear measure.

According to yet another aspect of the invention, an arrangement that is configured for determining operation conditions of a semiconductor, is presented, for which the operation conditions are compatible with a selected lifetime of the semiconductor device. This arrangement comprises assessing means that is adapted to assess information of predicted lifetime and operation condition statistics, based on obtained type of semiconductor device, and to access data of an operation history of the semiconductor device. The arrangement further comprises determining means that is adapted to determine an accumulated wear measure of the semiconductor device from information of predicted lifetime and operation condition statistics, based on the assessed data of the operation history of the semiconductor device. In addition, the arrangement also comprises obtaining means that is adapted to obtain a selected lifetime of the semiconductor device. Further still, the determining means is also adapted to determine operation conditions compatible with the selected lifetime of the semiconductor device, based on the determined accumulated wear measure.

According to a still another aspect of the present invention, a computer program for determining operation conditions of a semiconductor is disclosed. The operation conditions are compatible with a selected lifetime of the semiconductor device, and the computer program comprises instructions which, when run in a processor of an arrangement causes said arrangement to assess information of predicted lifetime and operation condition statistics, based on obtained type of semiconductor device. The computer program further comprises instructions which cause the arrangement to assess data of an operation history of the semiconductor device, and to determine an accumulated wear measure of the semiconductor device from information of predicted lifetime and operation condition statistics, based on the assessed data of the operation history of the semiconductor device. In addition, the computer program comprises instructions which, when run in a processor of the arrangement causes said arrangement to obtain a selected lifetime of the semiconductor device. In addition, the computer program comprises instructions which causes said arrangement to determine operation conditions compatible with the selected lifetime of the semiconductor device, based on the determined accumulated wear measure.

It is an advantage with embodiments of the invention that a semiconductor device can be reused.

A further advantage is that a processor may be reused for further or other applications, than was initially intended for the processor.

By updating the expected total lifetime, the determined wear measure WO(n) as well as the elapsed time, ET, new operation conditions can be determined for an updated expected lifetime.

By determining a wear measure of a semiconductor device at each time interval, and by taking this wear into account when determining the operation conditions that are compatible with a selected lifetime, the semiconductor device can be efficiently reused.

### BRIEF DESCRIPTION OF THE DRAWINGS

Embodiments will now be described in more detail, and with reference to the accompanying drawings, in which:

FIGS. 1 and 2 present flow charts of methods according to embodiments of the invention; and

FIGS. 3 and 4 schematically present an arrangement according to embodiments of the present invention.

### DETAILED DESCRIPTION

In the following description, different embodiments of the invention will be described in more detail, with reference to accompanying drawings. For the purpose of explanation and not limitation, specific details are set forth, such as particular examples and techniques in order to provide a thorough understanding.

Embodiments of the present invention enable determination of operation conditions of a semiconductor device, which conditions are compatible with a lifetime that can be selected.

In the following, a processor will at times be used herein instead of a semiconductor device. The processor is intended to denote any semiconductor device, and is thus not intended to restrict embodiments of the present invention to a processor.

Whenever a processor is operated, it is subjected to a wear that can eventually limit its lifetime.

General knowledge about a predicted lifetime of a processor can be gathered from statistics about the processor's lifetime at various operating conditions.

A manufacturer of a processor usually has extensive statistics information about the performance of processors at various operation conditions. Based on such data a predicted lifetime at said operation conditions can be statistically determined.

However, such a determination does not keep track of the wear that a processor is subjected to when it is operated at operation conditions.

By monitoring operation conditions during utilization of the processor an operation history is defined. From this operation history a wear contribution per time interval of operated processor, is calculated. A total wear after an operation time is then an accumulation of all wear contributions of each preceding time interval.

Based on a selected lifetime of the processor, the total wear of the processor and time during which the processor has been in operation, operating conditions for the processor can be determined.

A new or unused processor has typically a wear measure that is close to zero (=0). A used processor has a non-zero wear measure. However, both the new and the used processor can be chosen for a selected lifetime. Although both processors may be used for the same lifetime, their performance as reflected by the operating conditions is likely to differ. Dependent on how the used processor was operated, it can be operated at either a relatively low voltage, temperature or frequency, or a relatively high voltage, temperature or frequency, as will be determined for an unused processor.

It is basically known how the temperature and the voltage affect the wear of a processor and therefore also the lifetime, i.e. time to hard error, of the processor. It is mentioned that also the frequency of the processor can be of importance and be taken into account. However, a processor is also operated at the highest frequency for each voltage. If the frequency shall be decreased, the voltage is decreased instead, which implies that the frequency is decreased also. In the reverse way, when there is a desire to increase the frequency, the voltage has to be increased at first, after which the frequency can be increased. Since the voltage is affected for both an increase as well as a decrease in frequency, the following discussion herein will focus on the temperature of a processor and the voltage applied to the processor.

In the following some embodiments will be described in more detail.

The determination of operation conditions compatible with a selected lifetime of a semiconductor device, such as a processor, can be performed as described below.

The lifetime of a processor can be denoted as:

L=C1·exp(AT+BV+C), (1)

wherein T is the temperature of the processor in Kelvin (K), V is the voltage applied to the processor in Volt (V), and exp is the exponential function. C1, A, B and C are constants, which are typically set by the manufacturer of the processor.

As the determination of operating conditions as described herein takes into account a wear of the processor, a wear measure is denoted as:

WO(n)=WO(n−1)+Δt(n)/L(n),

wherein Δt(n) is a time interval t(n)−t(n−1) during which a predicted lifetime of the processor is L(n), which L(n) can be determined from equation (1). For a new or unused processor WO(n=0)=0.

It should be noted that whenever determining WO(n), the actual temperature T(n) and voltage V(n), applied to the semiconductor or processor under Δt(n) shall be used. This is in contrast to when determining the operation conditions that are compatible with a selected lifetime, wherein the operation conditions comprising T(n) and V(n), in this case refer to a temperature and a voltage that can be applied during t(n+1)−t(n), to achieve a maximum performance of the semiconductor device or processor.

The time period during which a processor is operated is defined as an elapsed time and is denoted ET.

The time period, during which the processor is expected to be in use is defined as an expected lifetime, XL, e.g. the time to a scheduled change of application, due to replacement or others.

Further, let an expected total lifetime XT, be defined as

XT=XL+ET,

wherein XL is the expected lifetime and ET the elapsed time during which the processor is operated.

For a new or unused processor XT=XL+0. In the case a processor is changed for other applications, XT=XL+ET, wherein XL is the expected lifetime for the new application, and ET is the time period during which the processor has been operated before the change to other applications.

Upon operation of the processor, for time intervals Δt(n), where n=1, . . . N, it is determined the elapsed time is incremented by

ET(n)=ET(n−1)+Δt(n).

The lifetime L(n) and WO(n) become:

L(n)=C1·exp[AT(n)+BV(n)+C], and

WO(n)=WO(n−1)+Δt(n)/L(n), respectively.

T(n) and V(n) denote the temperature and voltage, respectively, at time t(n).

The wear at time t(n) is thus determined as the wear at time t(n−1), plus the time interval Δt(n) divided by the lifetime L(n) at time t(n). Further, Δt(n)/L(n) can be regarded as an aging ratio of time t(n).

Also, an elapsed time ratio is defined as ET(n)/XT, i.e. the time during which the processor has been in operation divided by the total expected lifetime. This is hence a measure of how long the processor has been in operation relative the total expected lifetime of the processor.

In addition, the ratio between the wear measure WO(n) and the elapsed time ratio is defined, as a ratio of the wear to elapsed time ratio, and can thus be written as

WO(n)/[ET(n)/XT].

This ratio is an important measure, since it comprises information on how the processor has been running The processor history is hence reflected in this ratio. If this ratio is <1, the processor has generally been utilized to a lower degree, or sub-utilized, in relation to the performance enabling a lifetime of XT. If this ratio is >1, the processor has been utilized to a higher degree, or over-utilized.

This ratio can be >1 if, for instance, the expected lifetime is prolonged.

If the processor is in fact run at a voltage Vreal that is lower than V(n), within an interval, for instance due to that the performance that is required for an application corresponds to the voltage Vreal, WO(n) will not increase as much as the ratio ET(n)/XT, for which reason the ratio WO(n)/(ET(n)/XT) will decrease.

The ratio WO(n)/(ET(n)/XT) can be regarded as a memory or knowledge of how the processor has been operated, and hence reflects the operation history of the processor.

Equation 1 states the lifetime of the processor at various operating conditions. However, as the processor is subjected to wear when being operated the lifetime of the processor can be written as

XT·(WO(n)/[ET(n)/XT])=C1·exp[AT(n)+BV(n)+C] (2)

The operation conditions can thus be determined from equation 2. For instance at a fixed temperature T(n), the voltage V(n) can be determined.

It is noted that T(n) and V(n) are functions of time t(n). Thus, T(n) as well as V(n) can differ from time t(n), to time t(n+1). Since these parameters are functions of time, they are accordingly determined per time also.

It is further noted that the actual operating conditions used are dependent on the required performance of the processor. A processor is typically not run at a higher speed than required at each instance in time.

For this reason, a processor may be run at a lower voltage Vreal than as determined by equations herein, cf. V(n). Running the processor at the lower voltage creates a reduced wear of the processor. Since the determination of conditions compatible with a selected lifetime takes an accumulated wear into account, this reduced wear is taken into account when determining the operating conditions. Thus, although the calculated operating conditions are not applied, for one or the other reason, the effect of such operating is taken into account when determining conditions that are compatible with future operating conditions.

From equation 2, the voltage V(n) can be determined as

V(n)=1/B·(1n[(XT·XT·WO(n))/ET(n)·C1)]−AT(n)−C), (3)

wherein V(n) from equation 3, is the voltage to be applied at time t(n), for a maximum performance of the processor throughout the lifetime XT.

V(n) is the maximum voltage that can be applied to the processor in order to enable the lifetime XT, given the temperature T(n). V(n) can of course be used if maximum performance is required, until next time t(n+1), takes place, for which the procedure of determining operation conditions compatible with a selected lifetime is again performed, calculating V(n+1), etc.

It is however noted that the processor may have a defined maximum voltage level, Vmax, which should not be exceeded. If the calculated V(n)>Vmax, V(n) is reset to Vmax.

Embodiments of the present invention provide the expected lifetime, XL, of a semiconductor device, such as a processor, as a lifetime parameter, which is selected when the operation of the processor is started. As noted above, XL can be updated after the operation of the processor is started, or at reuse of the processor for an application.

Based on the expected total lifetime, XT, that is determined as XL+ET, operation parameters will be controlled such that a lifetime goal is achieved. This lifetime goal is that a processor shall be fully utilized, i.e. statistically worn out, when the expected total lifetime has lapsed.

At each time t(n), the operating conditions are determined by determining the maximum allowed voltage V(n) that can be applied to the processor to reach the expected total lifetime, XT, for the current temperature T(n). The voltage V(n) can be used if maximum performance is required during time interval from t(n) until t(n+1), at which the operation conditions are again determined.

As earlier described WO(n) is the wear at time interval n. As WO(n) is defined as

WO(n)=WO(n−1)+Δt(n)/L(n), WO(n) is an accumulated measure of wear over time period of ET(n).

The time interval n is defined as Δt(n)=t(n)−t(n−1). The wear contribution during time interval n is Δt(n)/L(n), wherein L(n) is the calculated lifetime under the conditions that are present during the time interval n, i.e. temperature T(n) and voltage Vreal applied to the processor.

Since the operating conditions T(n) and V(n) are calculated from data acquired during passed time intervals 1 to n, it is mentioned that the voltage V(n) and temperature T(n) denote the voltage and temperature, respectively, to be applied to the processor during time interval n+1, i.e. during t(n+1)−t(n).

As mentioned above, the operating conditions may also comprise a frequency F(n) of the processor, whereby equation 2 becomes

XT·(WO(n)/[ET(n)/XT])=C1·exp[AT(n)+BV(n)+DF(n)+C],

wherein D also is a constant and F(n) is the frequency of the processor at time t(n). Since the frequency F(n) is dependent on the voltage V(n) applied to the processor, and that the highest available frequency is assumed to be used for each applied voltage, the frequency F(n) will not be further discussed herein.

The total wear at a time interval n, i.e. WO(n) is thus an accumulated measure of wear during time intervals 1 to n. WO(n) is hence a measure of the present total wear of the processor at time t(n). If WO(n) is 0, the processor is new or completely unused. Whenever WO(n)=1, the processor is worn out, which means that the expected lifetime has been reached. If WO(n) is >1, the processor is running on “overtime”. It is noted that the processor may very well still be in operation and running when WO(n) exceeds 1. This only implies that the processor is operated on overtime, and that any guarantee for instance may no longer be valid.

As mentioned above, if the WO(n) does not increase in the same pace as the ratio ET(n)/XT, i.e. the processor is not operated by applying the maximum voltage V(n), but by applying a lower voltage, for the reason that the performance according to V(n) may not be needed or for the reason that V(n) would exceed an upper voltage limit of the processor, the ratio WO(n)/(ET(n)/XT) will successively decrease.

If the ratio is <1 and decreasing, it means that the determined voltage V(n), will successively increase for each time interval. This implies that when maximum performance is needed, a performance that is even higher than the one for a ratio WO(n)/[ET(n)/XT]=1, is available, until the wear WO(n) has increased and the ratio WO(n)/[ET(n)/XT]=1.

Down below a few illustrating examples of embodiments of the present invention will be presented.

### EXAMPLE 1

Pone that the expected total lifetime XT=3 years. Pone that after half the expected total lifetime, WO(n) is 0.1. This implies that ET(n) is 1.5 years, since half the expected total lifetime has passed.

It can be noted that the low value of WO(n) can be due to that the processor has only been utilized to a low degree, until now.

Equation 2 can thus be written,

XT·WO(n)/[ET(n)/XT]=3·0.1/[1, 5/3]=3·0.1/0.5=0.6 years

V(n) can thus be calculated from equation 3,

0.6=C1·exp[AT(n)+BV(n)+C]

This implies that until the next time t(n+1) the processor can be operated by using a V(n) which correspond to a lifetime of 0.6 years. The wear WO(n) will now increase faster than the ratio ET(n)/XT for each time increment, and therewith, the maximum performance corresponding to condition V(n) will successively decrease until the ratio WO(n)/[ET(n)/XT] approaches 1.

### EXAMPLE 2

Pone that the expected total lifetime XT=3 years. Also, pone that after half the expected total lifetime, WO(n) is 0.5. After half the expected total lifetime of 3 years, the expected lifetime XL is (again) defined to 3 years (from now on).

The expected total lifetime XT will be recalculated, XT=XL+ET(n) becomes XL=3 years+1.5 years=4.5 years. The wear WO(n) is maintained since the WO(n) is an accumulated measure of the wear of the processor. Equation 2 thus becomes:

XT·WO(n)/[ET(n)/XT]=C1·exp [AT(n)+BV(n)+C]

4.5·0.5/[1.5/4.5]=4.5·3·0.5/1=6.75 years

6.75=C1·exp [AT(n)+BV(n)+C]

This implies that until the next time t(n+1), V(n) will be limited such that this V(n) corresponds to a lifetime of 6.5 years. The wear WO(n) will therefore increase slower than the ratio ET(n)/XT for future times, whereby the maximum performance, as controlled by V(n), will be successively increased until WO(n)/[ET(n)/XT] approaches 1.

It is seen that in example 1 as well as example 2, the expected lifetime XL is met.

### EXAMPLE 3

Pone that the expected total lifetime XT=3 years, the elapsed time ET(n)=2 years, and the wear WO(n)=0.5. After ⅔ of the expected total lifetime, the expected lifetime is prolonged to another 3 years. XT thus becomes

XT=XL+ET(n)=3+2=5 years

Accordingly, equation 2 becomes

XT·WO(n)/[ET(n)/XT]=C1·exp [AT(n)+BV(n)+C]

5·0.5/[⅖]=5·1.25=6.25=C1·exp [AT(n)+BV(n)+C]

This implies that until the next time t(n+1) the processor can be operated by using a V(n) that corresponds to a lifetime of 6.25 years. Compared to example 2, in this example 3 it is allowed to operate the processor with operation conditions which correspond to a lifetime that is a bit shorter as compared to example 2. This is due to that the processor is still only worn out to 50%, i.e. the WO(n)=0.5, after ⅔ of the expected total lifetime, whereas in example 2 the wear measure WO(n) had reached 0.5 already after half the expected total lifetime XT, since ET(n)=1.5 years.

### EXAMPLE 4

Pone that the expected total lifetime XT=3 years, the elapsed time ET(n)=2 years, and the wear WO(n)=⅔. After ⅔ of the expected total lifetime, the expected lifetime is again prolonged to 3 years. XT thus becomes

XT=XL+ET(n)=3+2=5 years

Accordingly, equation 2 becomes

XT·WO(n)/[ET(n)/XT]=C1·exp[AT(n)+BV(n)+C]

5·(⅔)/[⅖]=5· 5/3=8.33=C1·exp [AT(n)+BV(n)+C]

This implies that until the next time t(n+1) the processor can be operated by using a V(n) that corresponds to a lifetime of 8.33 years.

Compared to example 3, the operating conditions which the processor is allowed to be operated with correspond to a longer lifetime in example 4. The processor may be regarded as not to be allowed to run or operated as fast as the processor in example 3. This is due to that the processor was worn to ⅔, instead to only 0.5, after the same elapsed time period ET(n) of 2 years.

It can is noted that the determination according to embodiments of the present invention adopts a PI regulation, i.e. a proportional part and an integrating part.

According to another embodiment, a PID regulation is envisaged, in which also a derivative part of the ratio WO(n)/[Et(n)/XT] is utilized.

Hence according to a PID regulation equation 3 becomes:

XT·WO(n)/[ET(n)/XT]·(1+K·the derivative of (WO(n)/[ET(n)/XT]))=C1·exp [AT(n)+BV(n)+C],

wherein K is a constant that determines the regulation rate and stability of the regulation.

By using a PID regulation, a faster response can be achieved, as compared to a PI regulation. A PID regulation enables a more rapid change from a low utilization, relative the possible operation conditions and wear, to a higher utilization of the processor, or from a high to a lower utilization.

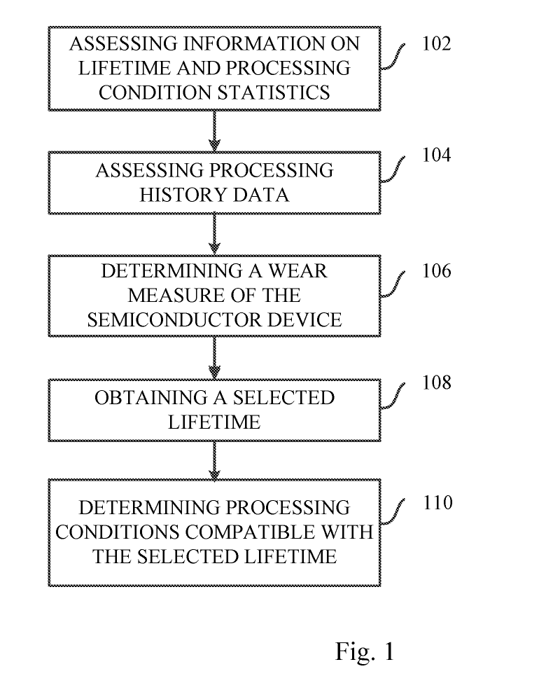

With reference to FIG. 1 a flow chart of a method for determining operation conditions of a semiconductor device, is presented. Within the method, the operation conditions are compatible with a selected lifetime of the semiconductor device. The method comprises assessing 102 information of predicted lifetime and operation condition statistics, based on obtained type of semiconductor device. It further comprises assessing 104 data of an operation history of the semiconductor device. The method further comprises determining 106 a wear measure of the semiconductor device from information of predicted lifetime and operation condition statistics, based on the assessed data of the operation history of the semiconductor device. Moreover, the method comprises obtaining 108 a selection of lifetime of the semiconductor device. In addition, it comprises determining 110 operation conditions compatible with the selected lifetime of the semiconductor device, based on the determined wear measure.

The information of predicted lifetime and operation condition statistics may comprise statistics information of lifetime dependent on semiconductor voltage.

The information of predicted lifetime and operation condition statistics may comprise statistics information of lifetime dependent on semiconductor temperature.

The data of the operation history of the semiconductor device may comprise temperature data of the semiconductor device sampled during time intervals.

The data of the operation history of the semiconductor device may comprise data of a voltage applied to the semiconductor device during time intervals.

The semiconductor device herein may comprise a processor, a blade to be used in a server, or other operation means.

Determining of an accumulated wear measure within the method for determining operation conditions may comprise accumulating a momentary wear measure of time intervals throughout a time period during which the semiconductor is operated.

Determining 110, 210 operation conditions compatible with the selected lifetime of the semiconductor device, within the method for determining operation conditions, may comprise using an algorithm relating the expected lifetime of the processor with operating conditions of the processor, wherein the expected lifetime is modified by a ratio comprising a wear measure of the processor.

The method for determining operation conditions may further comprise operating 212 the semiconductor device throughout a time duration, updating 214 the operation history and determining 206, 208, 210 operation conditions according to the updated operation history.

Embodiments of the present invention hence provide a possibility to reuse the semiconductor device for further applications.

By using a wear measure, there is provided a possibility to trade performance, given by operating conditions, to expected lifetime. Thus a processor, with an expected lifetime of for instance 3 years may provide a higher performance, i.e. be run at higher voltage and/or higher frequency when needed, as compared to a processor with an expected lifetime of say 15 years.

A processor can also be given a new or prolonged lifetime at any time during the usage of the processor.

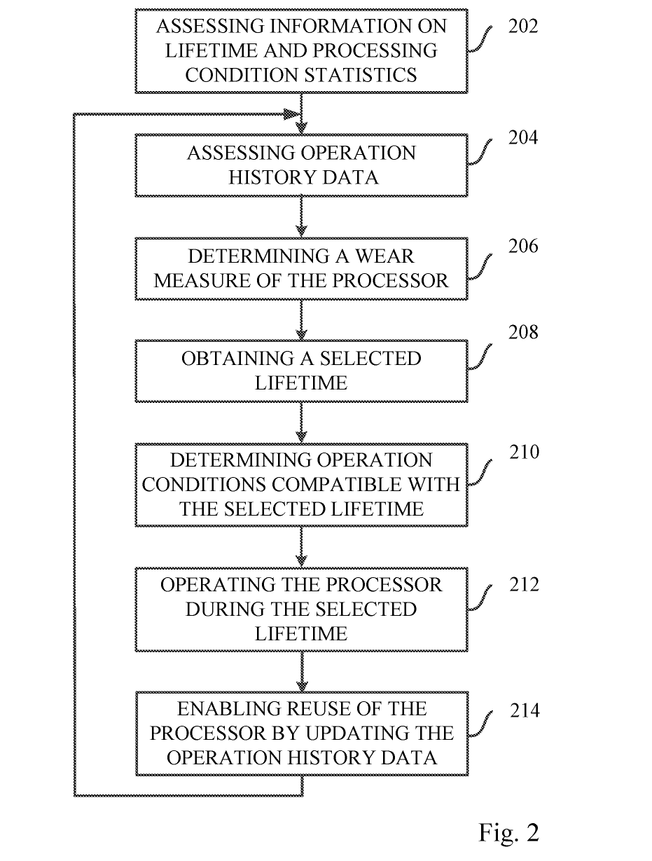

FIG. 2 presents a flow chart of a method for determining operation conditions of a semiconductor, according to some embodiments. This method is similar to the one as illustrate in FIG. 1, with the exception that this figure also illustrates an iterative property of the flow chart of FIG. 2. This iterative property comprises the ability to reuse the processor. This property will described down below.

The method may start with assessing 202 information of predicted lifetime and operation condition statistics, based on an obtained type of the processor. The operation history is then assessed 204 of the processor. An accumulated wear measure of the processor is then determined 206. This accumulated wear measure is based on information of predicted lifetime and operation condition statistics, and on the assessed data of the operation history of the semiconductor device. A selected lifetime of the processor is obtained in 208. The operation conditions compatible with the selected lifetime of the processor, based on the determined accumulated wear measure, are then determined 210.

In 212, the processor can then be operated throughout a time duration or during the selected lifetime. By operating the processor during a time duration, it is certified that the processor is subjected to a wear, with which the accumulated wear measure is updated. In 214 the operation history of the processor is updated. This comprises determining an accumulated wear of the processor.

Having updated operation history, the operation history is accessed in 204. Based on this accessed updated operation history, an updated accumulated wear measure is determined in 206. Based on the updated accumulated wear measure, the semiconductor device may be used during a novel selected lifetime, using updated operating conditions, for a novel or a further application. Operation conditions compatible with an updated or novel selected lifetime is determined in 210, similar to what was described above.

A processor can hence in this manner, be used for several applications.

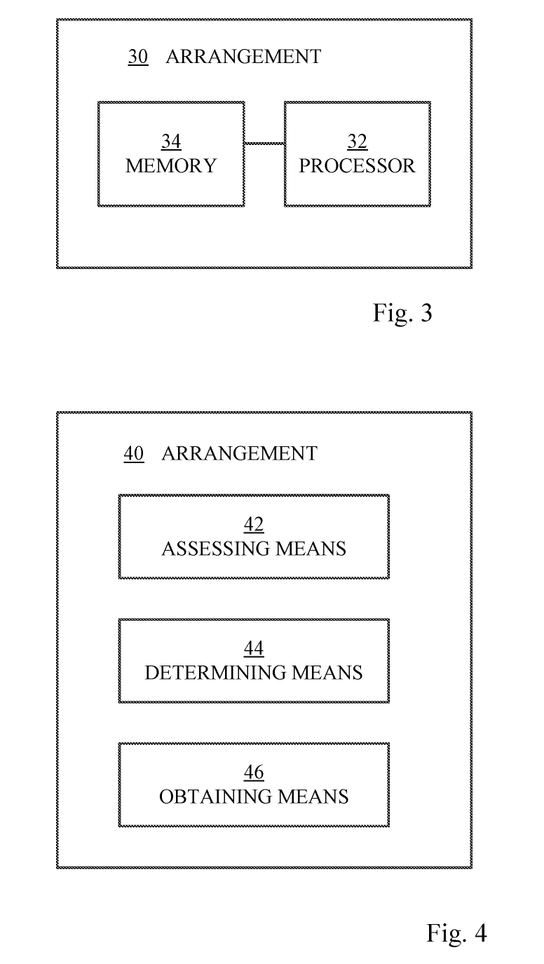

FIG. 3 presents a schematic presentation of an arrangement 30 that is configured to determine operation conditions of a semiconductor device, for which the operation conditions are compatible with a selected lifetime of the semiconductor device. The arrangement 30 comprises a processor 32 and a memory 34, wherein the memory stores a computer program that comprises instructions. When these instructions are run by the processor, they cause the arrangement 30 to:
assess 102, 202 information of predicted lifetime and operation condition statistics, based on obtained type of semiconductor device;
assess 104, 204 data of an operation history of the semiconductor device;
determine 106, 206 an accumulated wear measure of the semiconductor device from information of predicted lifetime and operation condition statistics, based on the assessed data of the operation history of the semiconductor device;
obtain 108, 208 a selection of lifetime of the semiconductor device; and
determine 110, 210 operation conditions compatible with the selected lifetime of the semiconductor device, based on the determined accumulated wear measure.

The memory 34 storing a computer program comprising instructions which when run by the processor, within the arrangement 30, may further cause the arrangement 30 to determine 110, 210 operation conditions compatible with the selected lifetime of the semiconductor device, by using an algorithm relating the expected lifetime of the processor with operating conditions of the processor, wherein the expected lifetime is modified by a ratio comprising a wear measure of the processor.

The memory 34 storing a computer program comprising instructions which when run by the processor, within the arrangement 30, may further cause the arrangement 30 to update 214 the operation history of the semiconductor device, after the semiconductor has been operated 212 throughout a time period, and to determine 204, 206, 208, 210 operation conditions according to the updated operation history.

Further, FIG. 4 schematically presents an alternative representation of an arrangement according to some embodiments of the present invention.

This alternative arrangement is configured to determine operation conditions of a semiconductor device, wherein said operation conditions are compatible with a selected lifetime of the semiconductor device. This arrangement comprises assessing means 42 that is adapted to assess 102, 202 information of predicted lifetime and operation condition statistics, based on obtained type of semiconductor device, and to access 104, 204 data of a operation history of the semiconductor device. The arrangement further comprises determining means 44 that is adapted to determine 106, 206 an accumulated wear measure of the semiconductor device from information of predicted lifetime and operation condition statistics, based on the assessed data of the operation history of the semiconductor device. In addition, the arrangement also comprises obtaining means 46 that is adapted to obtain 108, 208 a selected lifetime of the semiconductor device. Further still, the determining means 44 is also adapted to determine 110, 210 operation conditions compatible with the selected lifetime of the semiconductor device, based on the determined accumulated wear measure.

The memory 34 storing a computer program comprising instructions which when run by the processor, within the arrangement 30, may further cause the arrangement 30 to determine 110, 210 operation conditions compatible with the selected lifetime of the semiconductor device, by using an algorithm relating the expected lifetime of the processor with operating conditions of the processor, wherein the expected lifetime is modified by a ratio comprising a wear measure of the processor.

The memory 34 storing a computer program comprising instructions which when run by the processor, within the arrangement 30, may further cause the arrangement 30 to update 214 the operation history of the semiconductor device, after the semiconductor has been operated 212 throughout a time period, and to determine 204, 206, 208, 210 operation conditions according to the updated operation history.

According to a further aspect of the present invention, a computer program for determining operation conditions of a semiconductor is disclosed. The operation conditions are compatible with a selected lifetime of the semiconductor device, and the computer program comprises instructions which, when run in a processor 32 of an arrangement 30 causes said arrangement 30 to assess 102, 202 information of predicted lifetime and operation condition statistics, based on obtained type of semiconductor device. The computer program further comprises instructions which causes the arrangement to assess 104, 204 data of an operation history of the semiconductor device, and to determine 106, 206 an accumulated wear measure of the semiconductor device from information of predicted lifetime and operation condition statistics, based on the assessed data of the operation history of the semiconductor device. In addition, the computer program comprises instructions which, when run in a processor 32 of the arrangement 30 causes said arrangement 30 to obtain 108, 208 a selected lifetime of the semiconductor device. In addition, the computer program comprises instructions which causes said arrangement 30 to determine 110, 210 operation conditions compatible with the selected lifetime of the semiconductor device, based on the determined accumulated wear measure.

The computer program may further comprises instructions which when run by the processor, further causes the arrangement 30 to determine 110, 210 operation conditions compatible with the selected lifetime of the semiconductor device, by using an algorithm relating the expected lifetime of the processor with operating conditions of the processor, wherein the expected lifetime is modified by a ratio comprising a wear measure of the processor.

The computer program may comprises instructions which when run by the processor, further causes the arrangement 30 to update 214 the operation history of the semiconductor device, after the semiconductor has been operated 212 throughout a time period, and to determine 204, 206, 208, 210 operation conditions according to the updated operation history.

As the semiconductor device or processor of embodiments herein can be reused for other or further applications, the operation history needs to be accessed. This can be realized by persistently storing parameters in the semiconductor device. For instance, the expected lifetime XL, the expected total lifetime XT, the elapsed time ET, as well as the accumulated wears measure WO(n) may be stored in the semiconductor device, such that after a power disconnection, the value of these parameters can be regained. As an alternative to storing WO(n), the temperature of and the voltage applied to, the semiconductor device during ET can be stored.

Embodiments of the present invention have the following advantages:

It is clearly an advantage to provide a possibility to reuse a semiconductor device, such as a processor, in a reliable manner.

A further advantage is that a processor may be reused for further or other applications, than was initially intended for the processor.

By updating the expected total lifetime, the determined wear measure WO(n) as well as the elapsed time, ET, new operation conditions can be determined for an updated expected lifetime.

By determining a processor wear at each time interval, and by taking this wear into account when determining the operation conditions that are compatible with a selected lifetime, a processor can be efficiently reused.

It may be further noted that the above described embodiments are only given as examples and should not be limiting to the present invention, since other solutions, uses, objectives, and functions are apparent within the scope of the invention as claimed in the accompanying patent claims.

1. A method for determining operation conditions of a semiconductor, said operation conditions being compatible with a selected lifetime of the semiconductor device, the method comprising:
assessing information of predicted lifetime and operation condition statistics, based on obtained type of semiconductor device;
assessing data of an operation history of the semiconductor device;
determining an accumulated wear measure of the semiconductor device from information of predicted lifetime and operation condition statistics, based on the assessed data of the operation history of the semiconductor device;
obtaining a selected lifetime of the semiconductor device; and
determining operation conditions compatible with the selected lifetime of the semiconductor device, based on the determined accumulated wear measure.

2. The method for determining operation conditions according to claim 1, wherein the information of predicted lifetime and operation condition statistics comprises statistics information of lifetime dependent on semiconductor voltage.

3. The method for determining operation conditions according to claim 1, wherein the information of predicted lifetime and operation condition statistics comprises statistics information of lifetime dependent on semiconductor temperature.

4. The method for determining operation conditions according to claim 1, wherein data of the operation history of the semiconductor device comprises temperature data of the semiconductor device sampled during time intervals.

5. The method for determining operation conditions according to claim 1, wherein data of the operation history of the semiconductor device comprises data of a voltage applied to the semiconductor device during time intervals.

6. The method for determining operation conditions according to claim 1, wherein determining an accumulated wear measure comprises accumulating a momentary wear measure of time intervals throughout a time period during which the semiconductor is operated.

7. The method for determining operation conditions according to claim 1, wherein determining (110, 210) operation conditions compatible with the selected lifetime of the semiconductor device, comprises using an algorithm relating the expected lifetime of the processor with operating conditions of the processor, wherein the expected lifetime is modified by a ratio comprising a wear measure of the processor.

8. The method for determining operation conditions according to claim 1, further comprising operating the semiconductor device throughout a time duration, updating the operation history and determining operation conditions according to the updated operation history.

9. An arrangement configured to determine operation conditions of a semiconductor device, said operation conditions being compatible with a selected lifetime of the semiconductor device, the arrangement comprising:
a processor; and
a memory storing a computer program comprising instructions which when run by the processor, causes the arrangement to:
assess information of predicted lifetime and operation condition statistics, based on obtained type of semiconductor device;
assess data of an operation history of the semiconductor device;
determine an accumulated wear measure of the semiconductor device from information of predicted lifetime and operation condition statistics, based on the assessed data of the operation history of the semiconductor device;
obtain a selection of lifetime of the semiconductor device; and
determine operation conditions compatible with the selected lifetime of the semiconductor device, based on the determined accumulated wear measure.

10. The arrangement according to claim 9, wherein the memory storing a computer program comprising instructions which when run by the processor, further causes the arrangement to determine operation conditions compatible with the selected lifetime of the semiconductor device, by using an algorithm relating the expected lifetime of the processor with operating conditions of the processor, wherein the expected lifetime is modified by a ratio comprising a wear measure of the processor.

11. The arrangement according to claim 9, wherein the memory storing a computer program comprising instructions which when run by the processor, further causes the arrangement to update the operation history of the semiconductor device, after the semiconductor has been operated throughout a time period, and to determine operation conditions according to the updated operation history.

12. A computer readable medium containing computer program instructions for determining operation conditions of a semiconductor, said operation conditions being compatible with a selected lifetime of the semiconductor device, the computer program instructions, when run in a processor of an arrangement, causing said arrangement to:
assess information of predicted lifetime and operation condition statistics, based on obtained type of semiconductor device;
assess data of an operation history of the semiconductor device;
determine an accumulated wear measure of the semiconductor device from information of predicted lifetime and operation condition statistics, based on the assessed data of the operation history of the semiconductor device;
obtain a selected lifetime of the semiconductor device; and
determine operation conditions compatible with the selected lifetime of the semiconductor device, based on the determined accumulated wear measure.

13. The computer readable medium according to claim 12, wherein the computer program instructions, when run by the processor, further cause the arrangement to determine operation conditions compatible with the selected lifetime of the semiconductor device by using an algorithm relating the expected lifetime of the processor with operating conditions of the processor, wherein the expected lifetime is modified by a ratio comprising a wear measure of the processor.

14. The computer readable medium according to claim 12, wherein the computer program instructions, which when run by the processor, further cause the arrangement to update the operation history of the semiconductor device, after the semiconductor has been operated throughout a time period, and to determine operation conditions according to the updated operation history.

15. (canceled)
